(19) United States
(12) Patent Application Publication
(10) Pub. No.: US 2012/0057608 A1
(43) Pub. Date: Mar. 8, 2012

(54) INTRA-CAVITY SUM-FREQUENCY MIXING USING SOLID-STATE AND SEMICONDUCTOR GAIN-MEDIA

(75) Inventors: Wolf Seelert, Lubeck (DE); Rüdiger Von Elm, Wielen (DE)

(73) Assignee: Coherent GmbH, Gottingen (DE)

(21) Appl. No.: 12/877,786

(22) Filed: Sep. 8, 2010

(51) Int. Cl. H01S 3/11

(52) U.S. Cl. 372/10; 372/22

(57) ABSTRACT

A two-resonator laser arrangement for provides visible-wavelength radiation by sum-frequency mixing two different wavelengths of radiation circulating in the resonators in an optically nonlinear crystal located in the resonators. One of the resonators includes a solid-state gain-medium providing of one the two wavelengths and the other resonator includes a semiconductor gain-medium providing the other of the two wavelengths. A very short excited-state lifetime of the semiconductor gain-medium provides that noise and instability commonly encountered in the output of prior-art intra-resonator frequency-converted lasers is substantially reduced.

### TECHNICAL FIELD OF THE INVENTION

The present invention relates in general to intra-cavity frequency converted lasers. The invention relates in particular to intra-cavity frequency conversion by sum frequency mixing in a common leg of a branched laser-resonator.

### DISCUSSION OF BACKGROUND ART

Intra-cavity sum-frequency mixing in a branched laser-resonator has been proposed as a means of generating wavelengths in the visible spectrum that are not available using a simple intra-cavity frequency doubling approach with common solid-state gain-media. In such a branched resonator arrangement, one solid-state gain-medium is included in one of two separate branches for generating one wavelength of laser radiation and another solid-state gain-medium is included in the other separate branch for generating a different wavelength of laser radiation. An optically nonlinear crystal is included in a common branch for sum-frequency mixing the two different wavelengths. The arrangement has the advantage that the full circulating power of each branch is available for the sum-frequency conversion process, with power being extracted from the resonator combination only as sum-frequency radiation.

By way of example, in U.S. Pat. No. 5,345,457, a branched resonator is described wherein a neodymium-doped yttrium aluminum garnet (Nd:YAG) gain-medium is included in each of the separate branches, with end-mirrors of the branches arranged such that radiation having a wavelength of 1064 nanometers (nm) is generated in one branch and radiation having a wavelength of 1318 nm is generated in the other branch, both wavelengths, of course, being characteristic of the Nd:YAG gain-medium. Sum-frequency mixing in the common branch generates radiation having a wavelength of 589 nm. Sum-frequency mixing in the common branch provides that high circulating power of both wavelengths is available for sum-frequency mixing.

A potential problem with the sum-frequency generating arrangement of the '457 patent is that the generated sum-frequency radiation can be noisy. This is because solid-sate gain-media doped with rare earth or transition metals such as neodymium (Nd), thulium (Tm), holmium (Ho), erbium (Er), ytterbium (Yb), chromium (Cr), and praseodymium (Pr) all have long excited-state lifetimes ranging from several microseconds (μs) to a few milliseconds (ms).

It was recognized in a paper “Large-amplitude Fluctuations Due to Longitudinal Mode Coupling in Diode-Pumped Intracavity-Doubled Nd:YAG Lasers” T. Baer, J. Opt. Soc. Am., 3, 9, (1175-1179), September 1986, that when doing intra-cavity frequency-conversion in lasers with such gain-media, the long excited-state lifetimes gave rise to chaotic noise fluctuations and instability in the frequency converted output because of mode-coupling effects. These chaotic fluctuations became known to practitioners of the art as “the green problem” having been described in terms of frequency-doubling 1064-nm (Near-IR) radiation to provide 533-nm (green) radiation. Frequency doubling can be considered a special case of sum-frequency mixing wherein the wavelengths of radiation being mixed are equal.

In U.S. Pat. No. 5,446,749 (with the above-mentioned T. Baer as one of three inventors), a solution to the “green problem” is described. The solution involves increasing the number of fundamental longitudinal oscillating modes to a point where there are so many that the above discussed chaotic fluctuations “average out”. Generation of at least a few tens of modes is described as being necessary for the solution to be effective. This became, and still is, a commercially successful solution. Frequency-doubled output noise than 3% RMS is routinely achieved. A drawback, however, is that in order to generate the required number of modes a long resonator (with length well in excess of 1 meter) is required. This would provide problems in a branched resonator arrangement, and move away from a current trend to make commercial lasers with a compact “footprint”.

Another solution to the green-problem that has enjoyed equal commercial success is to perform intra-cavity frequency-doubling in a traveling-wave ring-resonator operating in a single longitudinal mode. Similar if not superior output noise reduction is achieved. It is difficult however to adapt a ring-resonator to a branched operation for sum-frequency mixing different wavelengths. Further, there is a practical long-wavelength operating limit for traveling-wave ring-resonators. This is due to practical long wavelength limits of optical diodes (absorption of which increases with increasing wavelength) needed to achieve unidirectional circulation in the resonator.

In U.S. Pat. No. 7,362,783 a sum-frequency mixing approach is claimed wherein one solid state gain-medium is a four-level gain-medium and the other is a three-level or quasi three-level gain-medium. It is argued that the two different solid-state gain-media allow more efficient generation of a wider range of wavelengths than would be possible with two of one or the other type of solid-state gain-medium. Sum-frequency-mixing arrangements described and claimed include the branched-resonator intra-cavity sum-frequency mixing arrangement of the above discussed '457 patent, and other arrangements, including extra-cavity sum-frequency mixing.

It is taught in the '783 patent that the sum-frequency mixing process is less noisy than frequency-doubling but that the system may still tend to be unstable, since the two lasers are subjected to a non-linear coupling by the frequency-converting mechanism. It is taught that the nonlinear coupling effect can be reduced by decoupling the two lasers by inserting the non-linear crystal in only one of the two laser cavities while the other one is isolated from the nonlinear sum-frequency mixing crystal. This of course requires giving up the more efficient coupled branched resonator arrangement. As the efficiency of the sum-frequency depends on the power of both radiations being mixed this means that whatever nose reduction is obtained is obtained at the expense of efficiency.

It is also taught in the '783 patent that the non-linear coupling can be avoided altogether by placing the nonlinear crystal outside of both resonators. This is referred to by practitioners of the art as “extra-cavity frequency mixing”, and is an even lower efficiency arrangement, suitable only for sum-frequency mixing high-intensity pulsed radiations, which in turn requires phase control for the two resonators to ensure temporal pulse overlap in the nonlinear crystal.

There is a need for a low-noise branched-resonator arrangement for intra-cavity sum-frequency mixing that requires neither long resonators nor ring-resonators. Preferably, the approach should be compatible with compact resonators, and should be suitable for continuous-wave (CW) or pulsed, Q-switched operation.

### SUMMARY OF THE INVENTION

In one aspect of the present invention, optical apparatus comprises an optically nonlinear element and first and second laser-resonators having first and second branches. The first and second laser-resonators are optically coupled such that the first branches thereof are coaxial with each other and the second branches thereof are separate from each other. The first laser-resonator includes a first gain-medium located in the second branch thereof, and the second laser-resonator includes a second gain-medium located in the second branch thereof. The first gain-medium has an excited-state lifetime greater than about 10 microseconds, and the second gain-medium has an excited-state lifetime less than about 100 nanoseconds. Means are provided for energizing the first and second gain-media such that radiation having a first wavelength circulates in the first laser-resonator and radiation having a second wavelength circulates in the second laser-resonator. The optically nonlinear element is located in the coaxial first branches of the first and second laser-resonators and arranged to sum-frequency mix the circulating first and second wavelength radiations to generate radiation having a third wavelength shorter than that of the first and second wavelengths.

In a preferred embodiment of the apparatus, the first gain-medium is a solid-state gain-medium and the second gain-medium is a surface-emitting semiconductor gain-medium. The short excited-state lifetime of the semiconductor gain-medium substantially reduces the above discussed noise and instability associated with prior-art intra-cavity frequency-converted lasers using only the longer lifetime solid-state gain-media.

In an example of the inventive laser wherein the solid-state gain-medium is Nd:YVO₄ generating radiation having a wavelength of 1342 nm, and the semiconductor gain-medium generates radiation having a wavelength of 1064 nm, 593 nm CW output stabilizes to less than 1% RMS noise about 50 microseconds after turn-on. Retaining one solid-state gain-medium in the inventive apparatus provides that the inventive apparatus can operated in a Q-switched mode in addition to being operable in the CW mode.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain principles of the present invention.

FIG. 1 schematically illustrates a preferred embodiment of branched-resonator, intra-cavity sum-frequency mixing laser apparatus in accordance with the present invention including a laser-resonator having first and second separate branches and common branch, with a solid-state gain-medium being located in the branch for generating first wavelength radiation and an OPS gain-structure being located in the second branch for generating second wavelength radiation, with an optically nonlinear crystal located in the common branch for sum-frequency mixing the first and second wavelengths.

FIG. 2A is a graph schematically illustrating calculated sum-frequency output as a function of time for prior-art apparatus similar to the apparatus of FIG. 1, but wherein the both resonator branches include a solid-state gain-medium with two oscillating modes in each resonator branch.

FIG. 2B is a graph schematically illustrating calculated intensity as a function of time of the individual oscillating modes in the resonator branches of the prior-art apparatus of FIG. 2A.

FIG. 2C is a graph schematically illustrating calculated gain-changes as a function of time corresponding to the intensity as a function of time of FIG. 2B.

FIG. 3A is a graph schematically illustrating calculated sum-frequency output as a function of time for an example of the inventive apparatus of FIG. 1, wherein the solid-state gain-medium has an excited-state lifetime of 90 microseconds and the OPS gain-structure has an excited-state lifetime of 0.01 microseconds.

FIG. 3B is a graph schematically illustrating calculated intensity as a function of time of the individual oscillating modes in the resonator branches of the example of the inventive apparatus of FIG. 1.

FIG. 3C is a graph schematically illustrating calculated gain-changes as a function of time corresponding to the intensity as a function of time of FIG. 3B.

FIG. 4A is a graph schematically illustrating measured sum-frequency output as a function of time for an example of the inventive apparatus of FIG. 1 wherein the solid-state gain-medium has an excited-state lifetime of about 90 microseconds and the OPS gain-structure has an excited-state lifetime of about 0.01 microseconds.

FIG. 4B is a graph similar to the graph of FIG. 4A, but having and expanded time scale to show further detail of the measured sum-frequency output as a function of time.

### DETAILED DESCRIPTION OF THE INVENTION

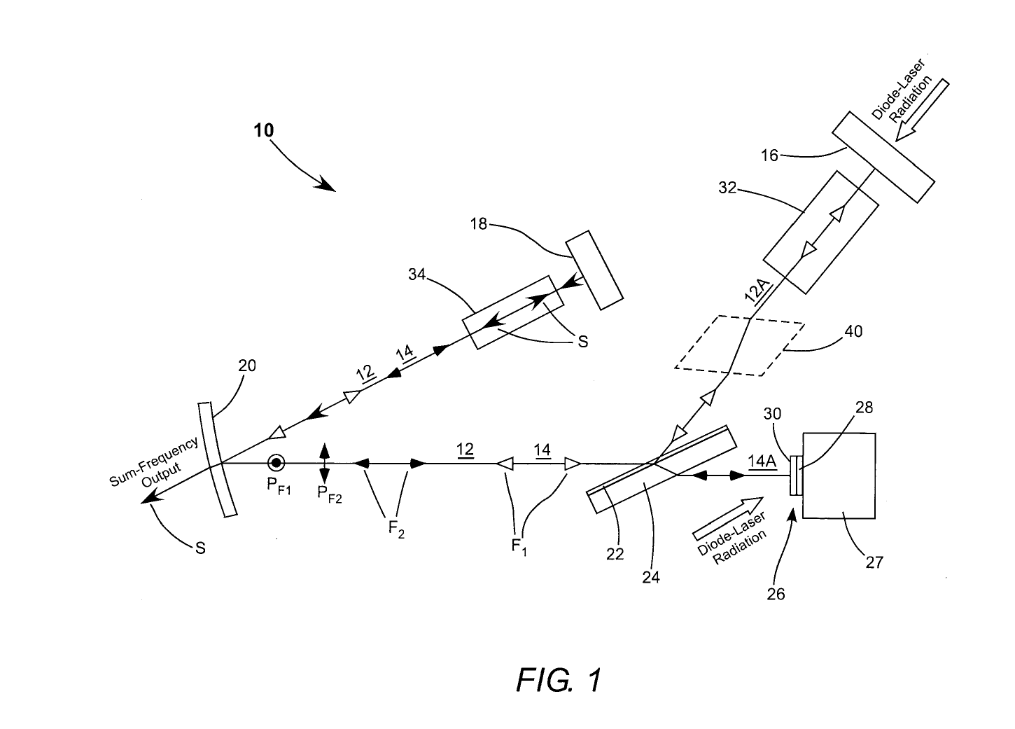

Referring now to the drawings, wherein like components are designated by like reference numerals, FIG. 1 schematically illustrates a preferred embodiment 10 of branched-resonator, intra-cavity sum-frequency mixing laser apparatus in accordance with the present invention. Laser 10 includes a laser-resonator 12 terminated by a plane mirrors 16 and 18, and a laser-resonator 14 terminated by mirror 18 and a mirror-structure 28 of an optically pumped semiconductor structure (OPS-structure) 26. OPS structure 26 is supported on a heat-sink 27. Resonator 12 is once-folded by a concave mirror 20. Resonator 14 is twice-folded, once by mirror 20 and again by a polarization-sensitive and wavelength-selective reflective and transmissive coating 22 on a birefringent filter 24.

Resonators 12 and 14 are co-axial between mirror 18 and reflective coating 22 on birefringent filter 24. The two resonators can be considered as a single, compound resonator comprising the common coaxial portion with two branches. One branch 12A is between coating 22 and mirror 16 and the other branch 14A is between coating 22 and mirror structure 28.

Resonator 12, in branch 12A thereof, includes a solid-state gain-medium 32, assumed here for example, to be neodymium-doped yttrium vanadate (Nd:YVO), and optionally, a Q-switch 40. Gain-medium 32 is end-pumped by diode-laser radiation delivered through mirror 16. The diode-laser radiation preferably has a wavelength of about 808 nm. Mirror 16 is highly reflective for the 1342 nm fundamental wavelength of the Nd:YVO₄ gain medium. Mirror 16 is coated to be highly reflective for 1342 nm and highly transmissive for the 808 nm.

As a result of the optical pumping of gain-medium 32, fundamental-wavelength radiation having a wavelength of about 1342 nm circulates in resonator 12 as indicated by arrowheads F₁. Coating 22 is designed for maximum reflectivity at 1342 nm for radiation s-polarized with respect to the filter, i.e., perpendicular to the plane of incidence. Accordingly, the circulating 1342-nm radiation is plane-polarized in a plane perpendicular to the drawing as indicated by arrowhead P_{F1}.

Resonator 14, in branch 14A thereof, includes a multilayer, surface-emitting, OPS gain-structure 30 of OPS-structure 26, surmounting mirror structure 28 of the OPS-structure. By way of example, gain-structure 30 can be an InGaAs/GaAs (active layers/substrate) structure having a peak-emission wavelength of about 1064 nm. Gain-structure 30 is optically pumped by diode-laser radiation preferably having a wavelength of about 830 nm, although pumping with 808-nm radiation is possible. Birefringent filter 24 is configured to select and fix a fundamental lasing wavelength from the gain-bandwidth of the OPS gain-structure. Coating 22 on birefringent filter 24 is designed to be maximally transmissive for p-polarized radiation (plane-polarized parallel to the plane of incidence of the filter) at the selected wavelength. Accordingly, when the OPS-structure is optically pumped, fundamental radiation having the fixed wavelength circulates in resonator 14 as indicated by arrowheads F₂. Because of the coating design and a Brewster angle inclination of the birefringent filter, radiation F₂ is plane-polarized in the plane of the drawing as indicated by arrowheads P_{F2}.

In the coaxial portions of resonators 12 and 14, adjacent mirror 18, is an optically nonlinear crystal 34 arranged for type-2 sum-frequency mixing of 1342-nm and 1064-nm radiation to provide radiation having a wavelength of about 593 nm, which is a useful wavelength for medical laser applications. Mirror 18 is coated for maximum reflectivity at both fundamental wavelengths and the sum-frequency wavelength. Sum-frequency radiation indicated by arrowheads S is generated in a double pass of the fundamental wavelength radiations in crystal 34, but once having been generated, propagates in only one direction away from the crystal. Mirror 20 is coated for maximum reflectivity at both fundamental wavelengths and for maximum transmission at the sum-frequency wavelength. Accordingly, the sum-frequency radiation exits the coaxial portion of resonators 12 and 14, via mirror 20, as output radiation.

In an experimental evaluation of the apparatus of FIG. 1, with gain-medium 32 being Nd:YVO₄ providing CW radiation at a wavelength of 1342 nm, and gain structure 30 of the OPS-structure 593-nm output stabilized rapidly to a noise level less than 1% RMS, a noise level comparable to or even less than is achieved in the best commercial frequency-converted solid state lasers. Further, this noise level was achieved with the solid-state resonator length being only about 500 millimeters (mm), less than would be required for multi-mode noise-free operation in a conventional intra-cavity frequency-converted solid-state laser. Before offering an explanation for this, a brief explanation of the physics of operation of intra-cavity frequency-converted resonators and resonators in general is set forth below.

The noise and instability experienced in prior-art intra-cavity sum-frequency conversion arrangements discussed above results from a strong interaction between gain (G), linear cavity (resonator losses) (α), intra-cavity (intra-resonator) intensity (I), nonlinear coupling (ε) mode-overlap (β). The interaction depends on the excited-state (fluorescence) lifetimes (τf1 and τf2) of the individual gain-media.

The nonlinear frequency conversion process is quasi instantaneous and depletes gain. It the excited-state lifetime of a gain-medium is long the (build-up) time for the gain to be replenished will be correspondingly long. If the mixed-mode gain is below threshold, the gain for an individual mode can be driven above threshold, which results in gain-switching from one mode to the other. This gain-switching may be permanently excited and may never be damped out. If the excited-state lifetime is sufficiently short, however, the buildup will be relatively rapid, and any initial gain-switching will be rapidly damped out.

There is always an interaction between the cavity lifetime (τ_{c}) of a laser-resonator (which depends on the resonator length and output coupling) and the excited-state lifetime if. This requires that for gain-media with a long τf, for example, greater than about 10 microseconds, a resonator length in excess of 1 meter is can provide for stable multi-mode operation. In the event that a compact resonator is required, for example, having length of about 50 cm or less, only a gain-medium with a short τf, for example, less than 100 nanoseconds (ns), will provide stable operation in an arbitrary number of longitudinal modes.

It would seem from the above discussed considerations that a branched resonator with two different short-lifetime gain-media, such as OPS gain-media would provide a solution for a compact coupled branched-resonator sum-frequency mixing arrangement with stable output. There are distinct disadvantages and shortcomings, however, in using two OPS gain-media to provide for the sum-frequency mixing. One disadvantage is that at wavelengths longer than about 1100 nm OPS gain-structures become less efficient and the maximum power limitation resulting from thermal roll-off is much less than at the shorter wavelengths. Another disadvantage is that Q-switched operation is not possible because of the same short excited-state lifetime that provides for stable operation. It is very important to retain a solid-state gain-medium as one of the gain-media at least because of long-wavelength efficiency.

On its face then, and assuming a system would only be as good as its weakest link, it would seem that the long-lifetime related noise problems of the solid-state gain-medium would mean that stability could only be achieved by taking one of the above-discussed prior-art measures to deal with those problems. The above discussed experimental results, however, indicated that this was not necessary. In order to understand why this occurred, it is necessary to investigate further the interactions between elements of the inventive sum-frequency arrangement. A discussion of such an investigation is set forth below.

The sum-frequency ISFG(n), where n is some arbitrary time, in a coupled two-branch resonator (where the nonlinear crystal interacts with both resonator branches) with two modes oscillating in each branch can be approximated by an equation:

ISFG(n)=I1(n)·I3(n)+I1(n)·I4(n)+I2(n)·I3(n)+I2(n)·I4(n) (1)

where I1, I2, are respectively the instantaneous intensities of the first and second modes of the first gain-medium and I3, and I4 are respectively the instantaneous values of the first and second modes of the second gain-medium. In order to compute ISFG(n) and gain as a function of time it is necessary to solve eight differential equations, more specifically, four pairs of differential equations, each pair having one element representing change in intensity with time and the other representing change of gain with time. This can be done numerically by computer, using a fourth order Runge-Kutta method. The vector of derivatives with respect to time is represented below by equation (2).

G02−(β2·y₄+β34·y₆+1)·y₅ (2)

In the vector-elements: y₀ and y₂ represent I1 and I2, the time-dependent intensities of the first and second modes of the first gain-medium; y₁ and y₃ represent G1 and G2, the time-dependent gains of the first and second modes of the first gain-medium; y₄ and y₆ represent I3 and I4, the time-dependent intensities of the first and second modes of the first gain-medium; y₅ and y₇ represent G3 and G4, the time-dependent gain of the first and second modes of the second gain-medium. For further clarification of the vector terms consider the first and second elements. The first element represents the intensity change with time of the intensity of the first mode of the first gain-medium, i.e.,

$$\frac{d }{d t} {y}_{0} := \frac{1}{τ c} \cdot [ {y}_{1} - a 1 - 2 \cdot ɛ \cdot ( {y}_{4} + {y}_{6} ) ] \cdot {y}_{0} \qquad ( 3 )$$

Here, τc is the resonator round trip time (determined by the resonator optical length), which, for convenience of calculation is assumed to be the same for both resonators; α1 is the linear loss for the first resonator, essentially the same for both modes of the resonator; and ε is the coupling coefficient for the sum-frequency generation and is applied to the sum of y4 and y6 (the intensities of the two modes from the other gain-medium).

The second element of vector (2) represents the gain-change with time of the first mode of the first gain-medium, i.e.,

$$\frac{d }{d t} {y}_{1} := \frac{1}{tf 1} \cdot [ G 01 - ( β 1 \cdot {y}_{0} + β 12 \cdot {y}_{2} + 1 ) \cdot {y}_{1} ] \qquad ( 4 )$$

Here, tf1 is the excited-state lifetime of the first gain-medium (the same for each mode); G01 is the small-signal gain for that gain-medium (gain the same for each mode); the product β1·y₀ is the gain saturation for the first mode of the first gain-medium; and the product β12·y₂ is the cross-saturation from the second mode of the first gain-medium. It should be noted that while only the first pair of terms of vector (2) have been explained, the other pairs of terms follow a similar pattern and the explanation of those will be evident from the foregoing explanation of the first pair of terms.

Now, despite the complexity of the mathematical model presented above it can be recognized that it is the gain-change elements of matrix (2) that depend on the excited-state lifetimes on the gain-media, and that those elements actually depend on the reciprocal of the excited state lifetime. This suggests, without being limited to a particular hypothesis, that in the case of the present invention, where the OPS gain-structure has a much shorter excited-state lifetime than that of the solid-state gain-medium it will be the OPS-resonator that dominates the stability of the sum-frequency generation arrangement and not (as would be expected on general consideration) the otherwise-noisy, solid-state resonator. This is confirmed by calculations and experimental results for an example of the branched resonator of FIG. 1 discussed in detail hereinbelow.

Calculations were made by computer using a fourth order Runge-Kutta routine in MATHCAD software available from PTC Corporation of Needham, Mass. Assumptions made in the calculations are as follows. Graphs were provided by plotting 40000 equally spaced points within a time period from t1=0 to t2=90 μs. Two modes in each resonator branch are assumed to oscillate. Each resonator branch has a length of 500 millimeters (mm) giving a value for τc of 3.33 ns. Each resonator is assumed to have the same linear loss α1=α2=0.01.

Solid-sate gain-medium 34 is Nd:YVO₄ (generating 1342-nm radiation), assumed to have a small signal gain (G01) of 0.12, an excited state lifetime τf1 of 90 μs, and saturation β1=1.0. The OPS gain-structure 30 (generating 1064 nm radiation) is assumed to have a small signal gain (G02) of 0.05, an excited state lifetime τf1 of 0.01 μs (10.0 ns), and saturation β2=1.0. Cross-saturation values were assumed as follows: β12=β21=0.5; and β34=β43=0.9.

The coupling coefficient (ε) for optically nonlinear crystal 34 was assumed to be 5 10⁻⁵. It was assumed that the optically nonlinear crystal was phase-matched only for sum-frequency generation between modes of the two resonator branches and not for generation of second-harmonics of individual modes or sum-frequency mixing between modes of the same resonator branch.

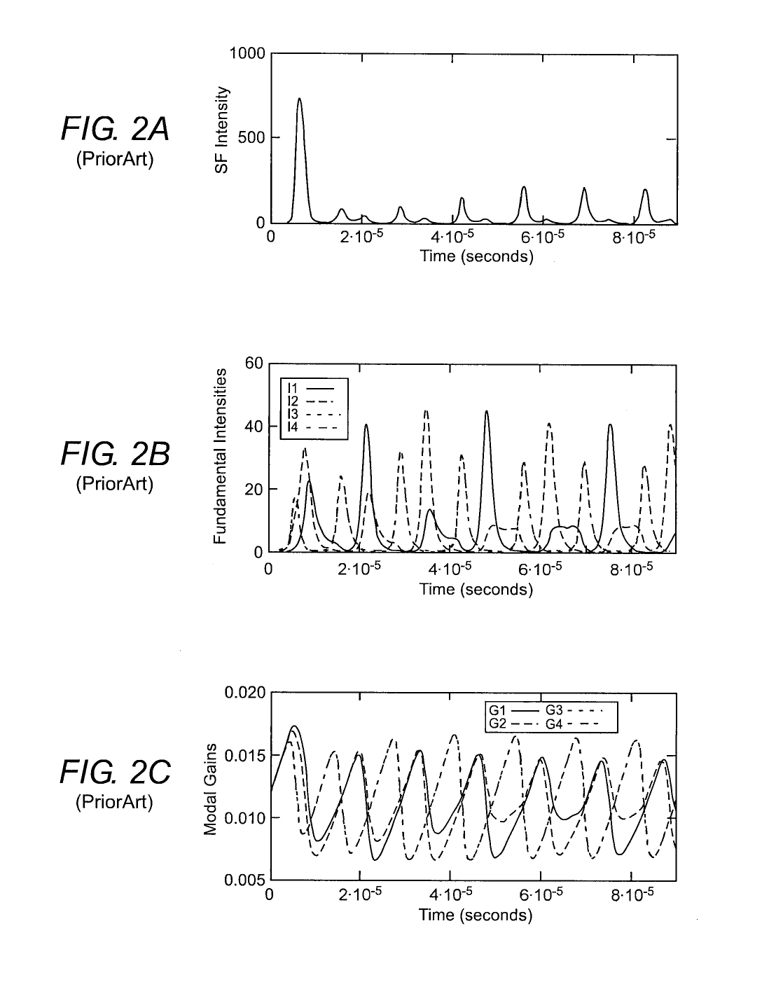

FIG. 2A is a graph schematically illustrating calculated sum-frequency intensity as a function of time for a branched resonator example wherein each branch includes a Nd:YVO₄ gain-medium. In the calculation the two resonators are started in an arbitrary unbalanced condition. It can be seen that after an initial high intensity spike the intensity continues to vary substantially with time with no sign of stabilizing. FIG. 2B and FIG. 2C are graphs schematically illustrating respectively the calculated variation of individual mode intensities (I1, I2, I3, and I4) and modal gains (G1, G2, G3, and G4) during the time period of FIG. 2A. Here again, there is significant variation, with no indication that stability will ever be achieved.

This unstable behavior is to be expected from the above-discussed teachings of the prior-art, as the resonator branches are too short to provide the noise mitigation proposed in the U.S. Pat. No. 5,446,749. The U.S. Pat. No. 7,362,783 teaches sum-frequency generation in a coupled branched resonator (with two solid-state gain-media) may tend to be unstable and recommends achieving stability by inserting the non-linear crystal in only one of the laser-resonators, with the other resonator being isolated from the nonlinear crystal.

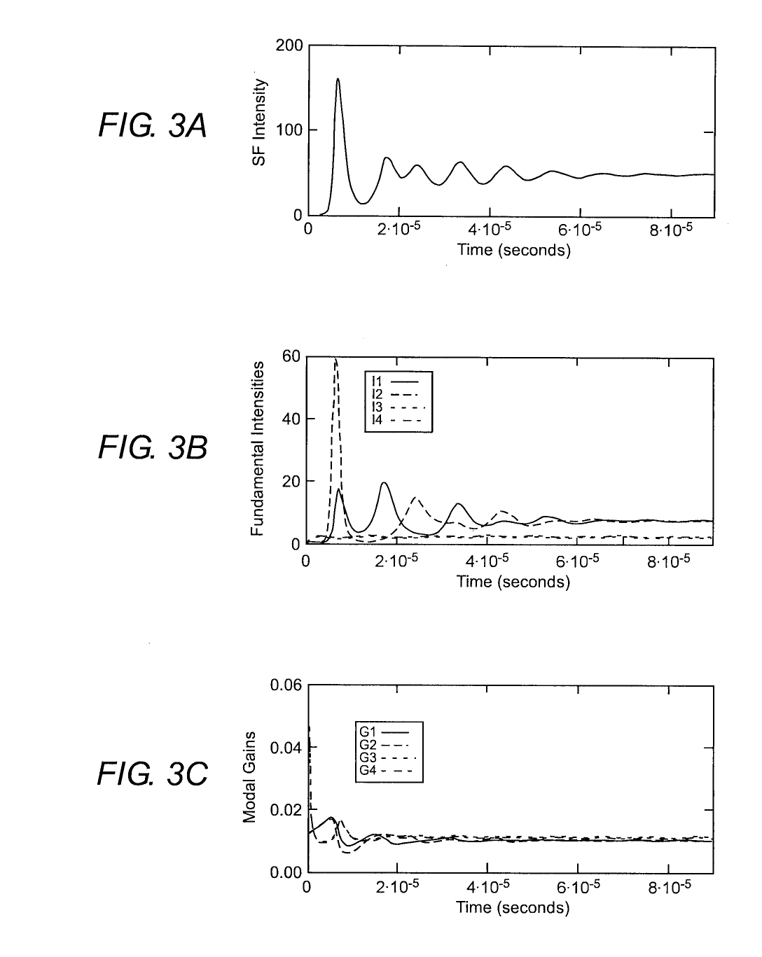

FIG. 3A is a graph schematically illustrating calculated sum-frequency intensity as a function of time for the branched resonator example of FIG. 1 wherein one resonator branch includes a Nd:YVO₄ (long excited-state lifetime) solid-state gain-medium and the other branch includes an OPS gain-structure with a much shorter excited-state lifetime that that of the solid state-gain-medium. Again in the calculation, the two resonators are started in an arbitrary unbalanced condition. In this case, however, after an initial high intensity spike (resulting from the non-equilibrium starting condition) fluctuations in intensity damp out rapidly with acceptably stable operation indicated after about 50 μs. FIG. 3B and FIG. 3C are graphs schematically illustrating respectively the calculated variation of individual mode intensities (I1, I2, I3, and I4) and modal gains (G1, G2, G3, and G4). Stability of the fundamental intensities is indicated after about the same time as for the sum-frequency intensity. Stability of the modal gains occurs after about 20 μs.

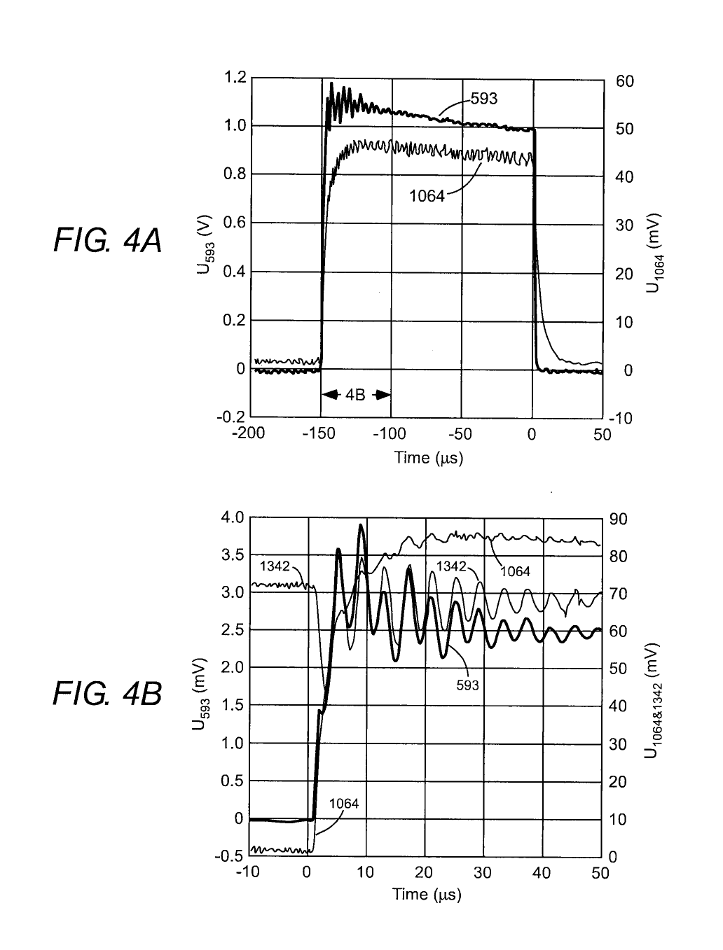

FIG. 4A is a graphical reproduction of an oscilloscope-trace measuring actual experimental performance of an example of the inventive arrangement of FIG. 1, with a Nd:VO₄ gain-medium generating 1342-nm radiation in resonator (branch) 12 and an OPS-structure generating 1064-nm radiation in resonator 14. FIG. 4B depicts the detail of the section of FIG. 4A between −150 and −100 microseconds and marked by the double arrows labeled 4B in FIG. 4A. (The scales in both FIGS. 4A and 4B are arbitrary.) In each graph the 593-nm output is shown by the bold curve. The resonators have about the 500-mm length assumed in the above-discussed calculations. Optically nonlinear crystal 34 is lithium tri-borate LBO. In the experiment, resonator 12 was operated to generate 1342-nm radiation continuously. Resonator 12 was switched on, and then switched off 150 μs later, by switching on and off the pump radiation delivered to the OPS-chip (see FIG. 4B). This was done to be able to evaluate the impact of the OPS-resonator on the system performance

Note that the initial sum-frequency spike of the calculated performance depicted in FIG. 3A is not present in the actual measurement, as such a spike is an artifact of the calculation. However, fluctuations thereafter are about the same. It can be seen that the fluctuations are substantially damped-out into the measurement noise after about the 50 μs of the theoretical prediction. It should be noted that in this actual apparatus it is likely that more than two modes were oscillating in each resonator and the number oscillating may not have been the same. In the measurement of FIG. 4A, the stable output shows a slow downward drift. It is believed that this is due to transit thermal effects in the OPS-chip. In a commercial apparatus, such drift could be corrected by a closed-loop power-control arrangement, adjusting, for example, diode-laser pump-power delivered to the gain-media to maintain a stable output level.

Recapitulating here, the present invention solves the problem of noise and in the output of an intracavity sum-frequency mixed branched coupled resonator laser having two solid-state gain-media by replacing one of the solid-state gain-media with a gain-medium having a very short excited-state lifetime. An optically pumped semiconductor gain-medium is one such gain-medium which is particularly suitable. The low-noise performance of the inventive laser is independent of the resonator length and can be achieved by a compact arrangements with resonator lengths less than about 0.5 meters. Gas laser gain-media have comparably short excited-state lifetimes but have low gain per unit length and accordingly require a long resonator to provide adequate power.

The short excited-state lifetime gain-medium is so effective in reducing above-discussed noise problems experienced in prior-art intra-cavity sum-frequency mixed solid-state lasers (which problems are due to the long excited-state lifetime characteristic of all solid-state gain-media), that one-solid state gain-medium can be retained in the inventive laser. Retaining one solid-state gain-medium is particularly important as that gain-medium can be used to generate wavelengths longer than about 1100 nm up to about 2000 nm which cannot be easily generated at the same power or efficiency with a OPS-gain structure. Solid state gain-media suitable for use in the present invention include any rare earth or transition metal doped host.

A wide-range of wavelengths shorter than 1100 nm can be generated using OPS structures. Suitable structures include, but are not limited to, InGaAsP/InP InGaAs/GaAs, AlGaAs/GaAs, InGaAsP/GaAs and InGaN/Al₂O₃ (active layer/substrate), which provide relatively-broad spectra of fundamental-wavelengths in ranges, respectively, of about 850 to 1100 nm; 700 to 850 nm; 620 to 700 nm; and 425 to 550 nm. There is, of course, some overlap in the ranges. This means that the inventive sum frequency laser can be configured to generate stable low-noise output at wavelengths from about 300 nm or less up to about 830 nm.

Another advantage of retaining a solid-state gain-medium is that it allows the inventive laser to be operated in a Q-switched pulse mode, by locating a Q-switch in the separate solid-state branch of the laser, as indicated by Q-switch 40 in resonator branch 12A of FIG. 1. This way a Q-switched pulse circulating in the common branch will be sum frequency mixed with CW OPS-laser radiation circulating in the common branch. OPS-lasers can not be Q-switched in any resonator arrangement because of the same short excited-state lifetime which is effective in solving the noise problem discussed above.

In summary, the present invention is described in terms of a preferred and other embodiments. The invention is not limited, however to the embodiments described and depicted herein. Rather the invention is limited only to the claims appended hereto.

What is claimed is:

1. Optical apparatus, comprising:
an optically nonlinear element;
first and second laser-resonators having first and second branches;
the first and second laser-resonators being optically coupled such that the first branches thereof are coaxial with each other and the second branches thereof are separate from each other;
the first laser-resonator including solid-state gain-medium located in the second branch thereof and the second laser-resonator including a surface-emitting semiconductor gain-medium located in the second branch thereof and wherein when said solid-state and surface-emitting semiconductor gain-media are energized, radiation having a first wavelength circulates in the first laser-resonator and radiation having a second wavelength circulates in the second laser-resonator; and
wherein the optically nonlinear element is located in the coaxial first branches of the first and second laser-resonators and arranged to sum-frequency mix the circulating first and second wavelength radiations to generate radiation having a third wavelength shorter than that of the first and second wavelengths.

2. The apparatus of claim 1, wherein the first wavelength is longer than the second wavelength.

3. The apparatus of claim 1, wherein the solid-state gain-medium has an excited-state lifetime greater than 10 microseconds and the surface emitting semiconductor gain-medium has an excited-state lifetime less than 100 nanoseconds.

4. The apparatus of claim 1, further including a Q-switch located in the second branch of the first laser-resonator.

5. The apparatus of claim 1, wherein the second branches of the first and second resonators are separated from each other by a dichroic reflector arranged at non-normal incidence to the circulating radiations.

6. The apparatus of claim 5, wherein dichroic reflector is highly reflective for first-wavelength radiation plane-polarized perpendicular to the plane of incidence of the dichroic reflector and the dichroic reflector is highly transparent for second-wavelength radiation plane polarized parallel to the plane of incidence of the dichroic reflector.

7. The apparatus of claim 6, wherein the dichroic reflector is coated on a birefringent filter arranged such that the birefringent filter is located in the second branch of the second resonator, the birefringent filter being configured to select the second wavelength from the gain-bandwidth of the surface-emitting semiconductor medium.

8. The apparatus of claim 1, wherein the first and second laser resonators have a common end-mirror at the end of the coaxial first branches thereof, the common end mirror being highly reflective for the first, second, and third wavelengths, wherein the coaxial first branches are folded by fold-mirror highly reflective for the first and second wavelengths and highly transparent for the third wavelength, and wherein the optically nonlinear crystal is located between the fold mirror and the common end-mirror, whereby the third wavelength radiation is generated by forward and reverse passes of the circulating first and second-wavelength radiations through the optically nonlinear element and exits the apparatus through the fold-mirror as output radiation.

9. Optical apparatus, comprising:
an optically nonlinear element;
first and second laser-resonators having first and second branches;
the first and second laser-resonators being optically coupled such that the first branches thereof are coaxial and the second branches thereof are separate from each other;
the first laser-resonator including first gain-medium located in the second branch thereof and the second laser-resonator including a second gain-medium located in the second branch thereof, the first gain-medium having an excited-state lifetime greater than about 10 microseconds and the second gain-medium having an excited-state lifetime less than 100 nanoseconds and wherein when said first and second gain-media are energized, radiation having a first wavelength circulates in the first laser-resonator and radiation having a second wavelength circulates in the second laser-resonator; and
wherein the optically nonlinear element is located in the coaxial first branches of the first and second laser-resonators and arranged to sum-frequency mix the circulating first and second wavelength radiations to generate radiation having a third wavelength shorter than that of the first and second wavelengths.

10. The apparatus of claim 9, wherein the first wavelength is longer than the second wavelength.

11. The apparatus of claim 9, wherein the first gain-medium is a solid-state gain-medium and the second gain-medium is a surface-emitting semiconductor gain-medium.

12. The apparatus of claim 11, wherein the first gain-medium is Nd:YVO₄, the first wavelength is about 1342 nanometers, the second wavelength is about 1064 nanometers and the third wavelength is about 593 nanometers.

13. The apparatus of claim 9, wherein the first and second laser resonators have a common end-mirror at the end of the coaxial first branches thereof, the common end mirror being highly reflective for the first, second, and third wavelengths, wherein the coaxial first branches are folded by fold-mirror highly reflective for the first and second wavelengths and highly transparent for the third wavelength, and wherein the optically nonlinear crystal is located between the fold mirror and the common end-mirror, whereby the third wavelength radiation is generated by forward and reverse passes of the circulating first and second-wavelength radiations through the optically nonlinear element and exits the apparatus through the fold-mirror as output radiation.

14. The apparatus of claim 9, further including a Q-switch located in the second branch of the first resonator.

15. An apparatus comprising:
a first optical resonator having a first gain element located therein;
a second optical resonator having a second gain element located therein, wherein a portion of the first resonator overlaps and is coaxial with a portion of the second resonator and with the first and second gain elements being located in the non-overlapping portions of the respective resonators; and
a non-linear crystal located in the overlapping portions of the resonators and configured for sum frequency mixing and wherein said first gain element is a solid state gain medium having an excited state lifetime of greater than 10 microseconds and wherein the second gain element is a semiconductor gain medium having an excited state lifetime of less than 100 nanosecond.

16. An apparatus as recited in claim 15, wherein the first and second resonators share a common end mirror located in the overlapping portion of the resonators.

17. An apparatus as recited in claim 16, wherein the overlapping portion of the resonators includes a fold mirror and wherein the non-linear crystal is located between the fold mirror and the common end mirror and wherein the fold mirror is arranged to outcouple sum frequency mixed radiation.

18. An apparatus as recited in claim 17, wherein the semiconductor gain medium is a surface emitting, optically pumped, gain medium.

19. An apparatus as recited in claim 15, further including a Q-switch located in the first optical resonator in the non-overlapping portion thereof.
